(19) United States
(12) Patent Application Publication
(10) Pub. No.: US 2008/0116034 A1
(43) Pub. Date: May 22, 2008

(54) Bill acceptor for money exchanging machine

(75) Inventor: Wen-Fu Yang, Taipei City (TW)

Correspondence Address: BIRCH STEWART KOLASCH & BIRCH, PO BOX 747, FALLS CHURCH, VA, 22040-0747, US

(73) Assignee: International Currencies Technology Corporation

(21) Appl. No.: 12/010,186

(22) Filed: Jan. 22, 2008

Related U.S. Application Data
(63) Continuation of application No. 11/164,601, filed on Nov. 30, 2005.

(51) Int. Cl. G07F 9/10

(52) U.S. Cl. 194/350

(57) ABSTRACT

A bill acceptor used in a money exchanging machine includes a bill box for collecting bills, and a bill receiving and verification unit, which has a bill slot for insertion of bills, a first bill passage extending from the bill slot, a second bill passage corresponding to the bill box, a conveyor for carrying each inserted bill from the bill slot through the first bill passage to the second bill passage, a camshaft and cross linkage mechanism movable to force each inserted bill from the second bill passage into the inside of the bill box, and a sensor. The sensor is formed of an optical emitter, an optical receiver and a reflecting device and turns on an indicator light when the bill box is empty or turns off the indicator light when the bill box has bills stored therein.

This application is a Continuation of co-pending application Ser. No. 11/164,601, filed on Nov. 30, 2005, and for which priority is claimed under 35 U.S.C. § 120, the entire contents of which are hereby incorporated by reference.

### BACKGROUND OF THE INVENTION

1. Field of the Invention

The present invention relates to a money-exchanging machine and more particularly, to a bill acceptor for money exchanging machine, which gives a first visual indication when the bill box has at least one bill received therein or a second visual indication when said bill box is empty.

2. Description of the Related Art

Following fast development of transportation and communication technology, business in non-shop business has become popular. Nowadays, various automatic vending machines are used everywhere to sell different products without serviceman. The use of automatic vending machines creates new marketing routes for the suppliers, and gives convenience to consumers.

Further, an automatic vending machine may be provided with a money-exchanging machine. A money-exchanging machine for this purpose comprises a bill acceptor that the bill acceptor of a conventional automatic vending machine controls bill authenticity verification, anti-theft operation, money return operation and coin/bill counting operation. According to conventional designs, the worker cannot know whether or not the bill box of the bill acceptor in a game machine or automatic vending machine is empty before opening it. Before opening the bill box to collect storage bills or coins, the worker must perform a complicated procedure to disarm the machine. Even if the bill box is empty, the worker can know the condition only after having opened the bill box. After removal of the storage bills from the bill box, the worker needs to write down the reading of the counter or sends the data to a host through the Internet. However, a company may have a great number of game machines, money exchange machines and/or automatic vending machines installed in different places. It takes much time and labor to open the bill box in each machine and to take the storage money from it. If a bill is left in the bill box due to a mistake when the worker picks up the storage bills, the machine gives no indication. If the amount of the collected bills does not match the count recorded, the worker may have to open and check the bill box of every machine. This checking procedure is also complicated, wasting much labor and time.

Further, the bill acceptor may be equipped with a counter or micro-switch to detect the full status of the bill box. There is known a bill box detecting design that uses solenoid detecting means to detect the bill receiving status of the bill box. The solenoid detecting means comprises a solenoid switch mounted in the bill box, and a magnetic member mounted in a pressure board corresponding to the solenoid switch. When the bill box is full, the solenoid detecting means turns on a signal light and cuts off the conduction loop. This bill box detecting design is functional, however it is not durable in use because the magnetic force of the magnetic member attenuates gradually with use, resulting in reduced sensitivity and false action. Further, the internal metal and electronic elements of the money-exchanging machine may interfere with the operation of the solenoid switch, causing the solenoid switch unable to function normally.

Although many different bill box full status detection designs have been disclosed, these designs are still not perfect. Therefore, it is desirable to provide a bill acceptor that accurately indicates the full or empty status of the bill box, and automatically cuts off the power supply or starts the machine subject to the full or empty status of the bill box.

### SUMMARY OF THE INVENTION

The present invention has been accomplished under the circumstances in view. According to one aspect of the present invention, the bill acceptor is used in a money exchanging machine, comprising a bill box for collecting bills, and a bill receiving and verification unit, which has a bill slot for insertion of bills, a first bill passage extending from the bill slot, a second bill passage corresponding to the bill box, a conveyer for carrying each inserted bill from the bill slot through the first bill passage to the second bill passage and then pushing the bill into the bill box, and a sensor for detecting the bill receiving status of the bill box and driving an indicator light to give a first visual indication when the bill box has at least one bill received therein or a second visual indication when said bill box is empty. The sensor comprises an optical emitter and an optical receiver disposed in the second bill passage at the top, and a reflecting device installed in a flat bearing board inside the bill box below the second bill passage and adapted to reflect light from the optical emitter onto the optical receiver.

According to another aspect of the present invention, the bill receiving and verification unit further comprises a detector installed in one side of the second bill passage and adapted to detect the accumulation status of bills in the bill box and to cut off power supply from the money exchanging machine when a predetermined amount of bills is accumulated in the bill box, and a sliding bar vertically slidably mounted in the bill box and movable between a first position where the sliding bar blocks the detector and a second position where the sliding bar is spaced away from the detector. The sliding bar is moved to the second position by the flat bearing board when a predetermined number of bills is received in the bill box at the flat bearing board.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 is an elevational view of a bill acceptor according to the present invention.

FIG. 2 is an exploded view of the bill receiving and verification unit of the bill acceptor according to the present invention.

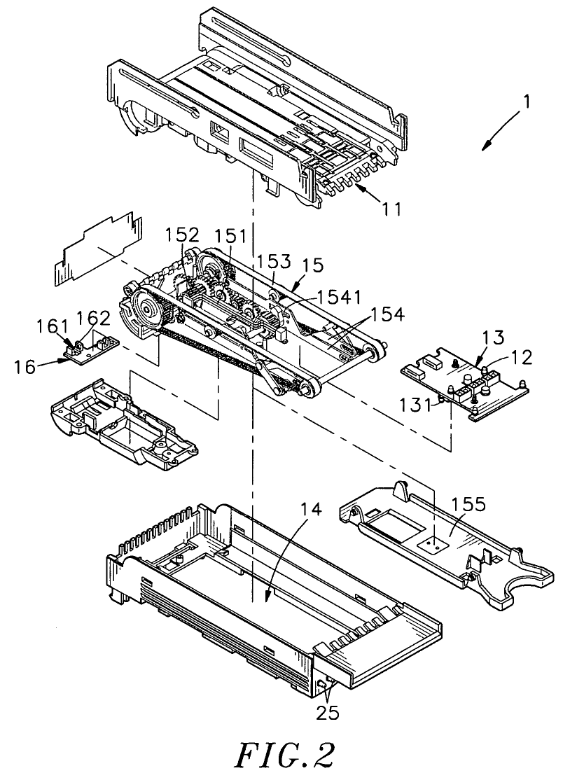

FIG. 3 is an exploded view of the bill box of the bill acceptor according to the present invention.

FIG. 4 is an exploded view of a part of the present invention, showing the structure of the sensor.

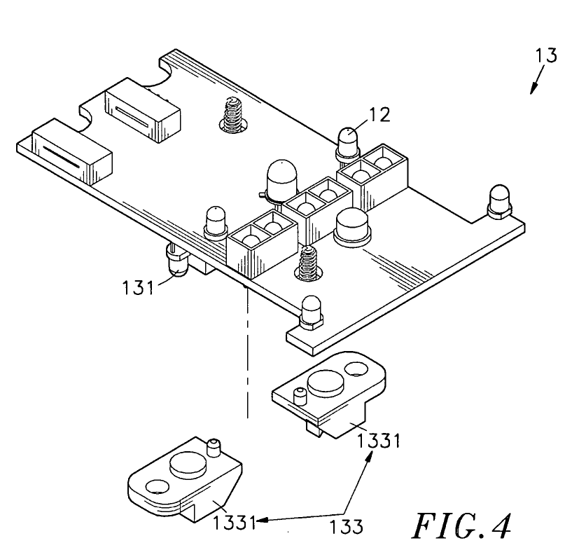

FIG. 5 is a schematic drawing showing the light path during operation of the sensor according to the present invention.

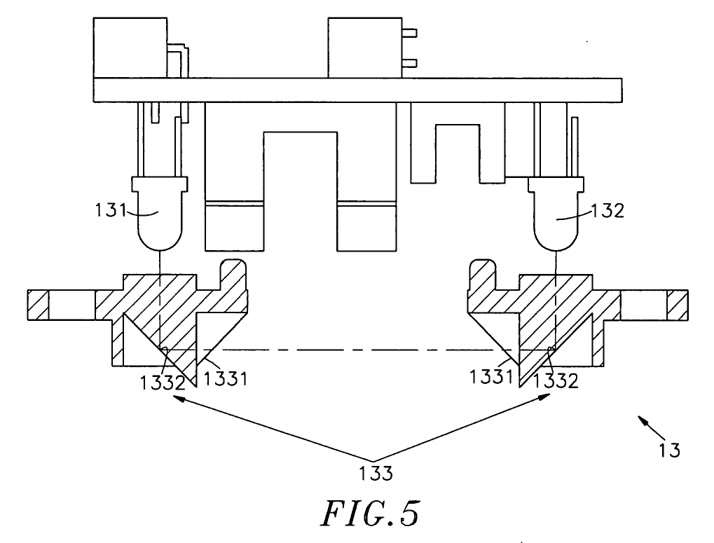

FIG. 6 is a sectional side view of the present invention, showing the status of the bill acceptor upon insertion of a bill into the bill slot.

FIG. 7 is similar to FIG. 6 but showing the inserted bill carried to the first bill passage.

FIG. 8 is similar to FIG. 6 but showing the inserted bill carried to the second bill passage.

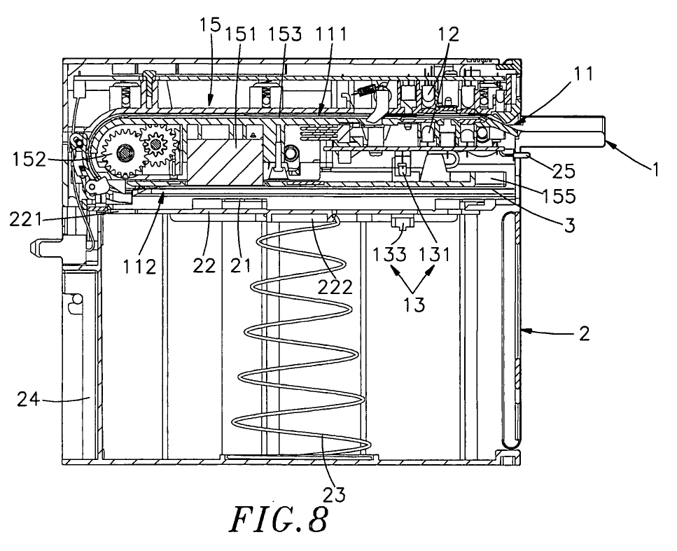

FIG. 9 is a schematic drawing of the present invention, showing the operation of the crossed linkage of the conveyer (I).

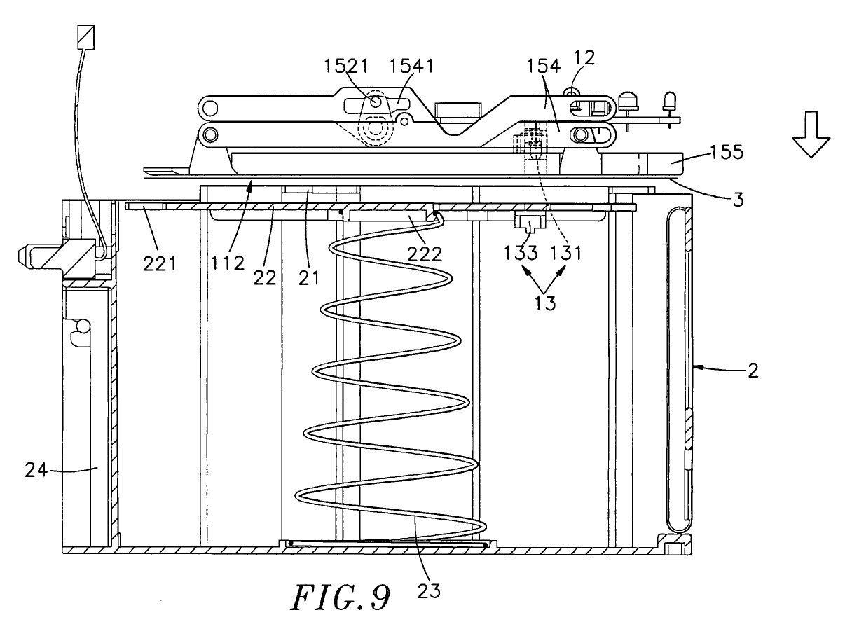

FIG. 10 is a schematic drawing of the present invention, showing the operation of the crossed linkage of the conveyer (II).

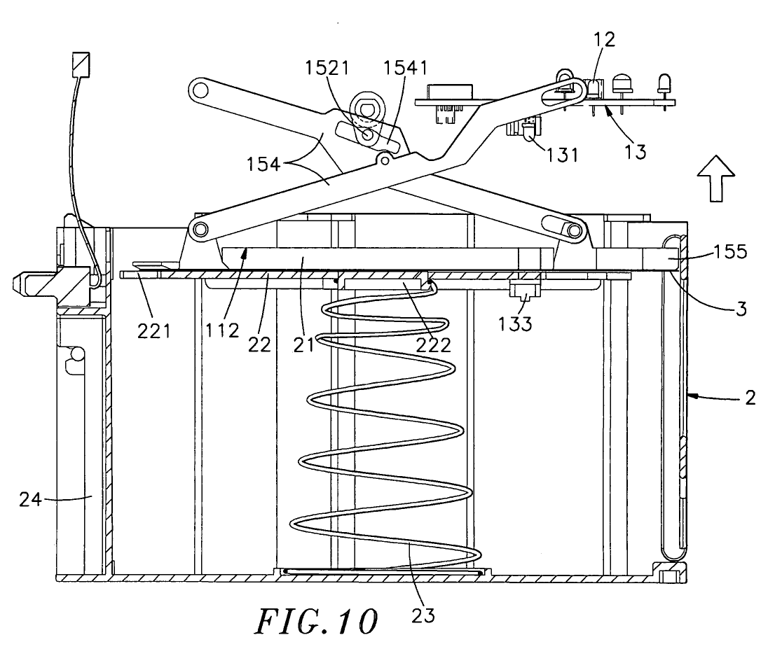

FIG. 11 is a schematic drawing of the present invention, showing the operation of the crossed linkage of the conveyer (III).

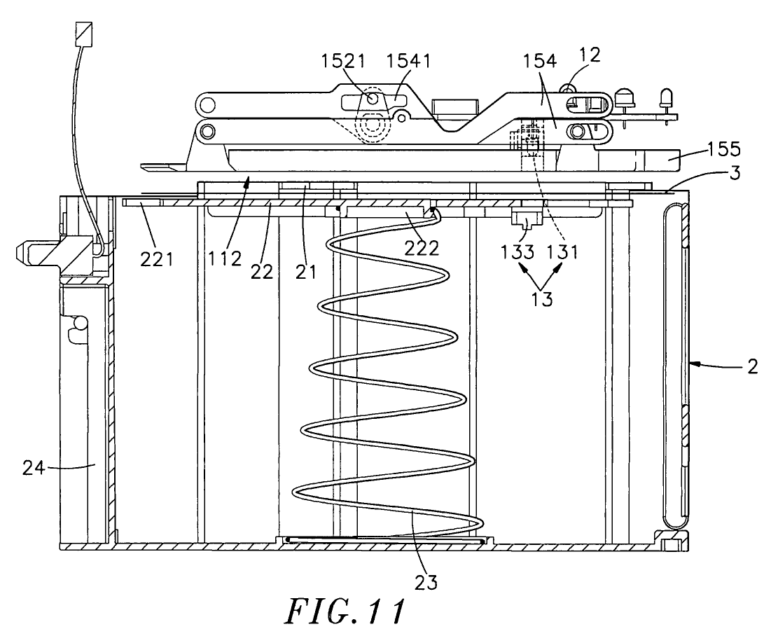

FIG. 12 is a perspective view of a part of the present invention, showing a limited number of bills received in the bill box.

FIG. 13 is similar to FIG. 12 but showing the full status of the bill box.

### DETAILED DESCRIPTION OF THE PREFERRED EMBODIMENT

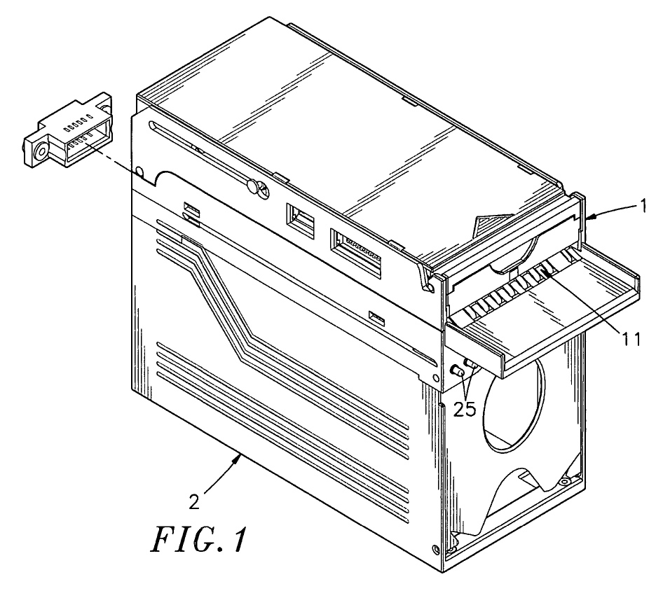

Referring to FIGS. 1˜4 and 7, a bill acceptor in accordance with the present invention is shown comprised of a bill receiving and verification unit 1 and a bill box 2.

The bill receiving and verification unit 1 comprises a bill slot 11 through which a bill is inserted, a first bill passage 111 extending from the bill slot 11, an accommodating chamber 14 defined beneath the first bill passage 111, a verification device 12 set in the first bill passage 111 for verifying the authenticity of the inserted bill, a second bill passage 112 in communication with the first bill passage 111, and a conveyer 15 mounted in the top side of the accommodation chamber 14 and extending between the first bill passage 111 and the second bill passage 112. The bill conveyer 15 comprises a motor 151, a transmission gear train 152 coupled to the motor 151, two conveying belts 153 coupled to the transmission gear train 152, a camshaft 1521 coupled to the motor 151, a pressure board 155, and a crossed linkage 154 coupled between the camshaft 1521 and the pressure board 155 and adapted to move the pressure board 155 up and down. The camshaft 1521 has one end inserted through a sliding slot 1541 at the crossed linkage 154. The second bill passage 112 is aimed at a flat bearing board 22 in the top open side of the bill box 2. The bill receiving and verification unit 1 further comprises a sensor 13. The sensor 13 comprises an optical emitter 131 and an optical receiver 132 mounted in the second bill passage 112 at the top, and a reflecting device 133 mounted in the bottom side of the flat bearing board 22. The reflecting device 133 comprises two reflecting elements 1331. Each reflecting element 1331 has a reflecting surface 1332. The reflecting surface of one reflecting element 1331 is adapted to reflect light from the optical emitter 131 onto the reflecting surface 1332 of the other reflecting element 1331 for enabling the reflecting surface 1332 of the other reflecting element 1331 to reflect the incident light onto the optical receiver 132. It is to be understood that the flat bearing board 22 has openings or light transmissive portions for allowing light to pass from the optical emitter 131 to the corresponding reflecting element 1331 or from the respective reflecting element 1331 to the optical receiver 132. Further, a detector 16 is installed in one side of the second bill passage 112. The detector 16 comprises a sensing element 162 that has a center through hole 161.

The bill box 2 is mounted in the bottom side of the accommodation chamber 14, having a plurality of stop rods 21 suspending around its top open side and holding the aforesaid flat bearing board 22 on the inside below the stop rods 21. Further, a spring member 23 is mounted inside the bill box 2 to support the flat bearing board 22. The spring member 23 has its top side fastened to a bottom connection hole 222 at the bottom side of the flat bearing board 22, and its bottom side fastened to the bottom wall of the bill box 2. The spring member 23 forces the flat bearing board 22 upwards toward the stop rods 21 against the pressure board 155 of the bill receiving and verification unit 1. Further, the flat bearing board 22 has a protruding block 221 at its one side. The bill box 2 has a sliding bar 24 vertically slidably mounted therein at one side. The sliding bar 24 has a stop block 241 disposed at its top side and adapted to block the center through hole 161 of the sensing element 162 of the detector 16, and a protruding rod 242 disposed at its bottom side and vertically spaced below the protruding block 221 of the flat bearing board 22. Before the bill box 2 is fully filled with bills, the protruding block 221 of the flat bearing board 22 is kept away from the protruding rod 242 of the sliding bar 24, and the stop block 241 of the sliding bar 24 keeps blocking the center through hole 161 of the sensing element 162 of the detector 16. On the contrary, when the bill box 2 is fully filled with bills, the protruding block 221 of the flat bearing board 22 is stopped against the protruding rod 242 of the sliding bar 24 to hold the sliding bar 24 in a lower limit position where the stop block 241 of the sliding bar 24 is kept away from the center through hole 161 of the sensing element 162 of the detector 16, causing the detector 16 to drive an indicator light 25 that is mounted in the bill receiving and verification unit 1.

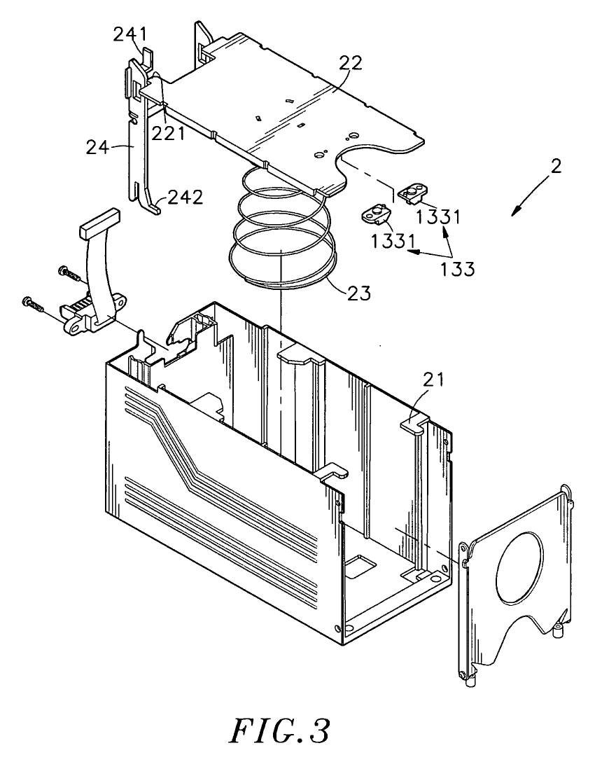

Referring to FIGS. 3˜5 again, the light path goes between the optical emitter 131 and the optical receiver 132 and the reflecting device 133 across the second bill passage 112. When a bill is moved to the flat bearing board 22, the bill blocks the optical emitter 131 and the optical receiver 132, causing the sensor 13 to cut off power supply from the indicator light 25. By means of the indication of the indicator light 25, the worker knows whether the bill box 2 has any bill stored therein or not. Therefore, the worker will not waste time in opening the bill box 2 when the bill box 2 is empty.

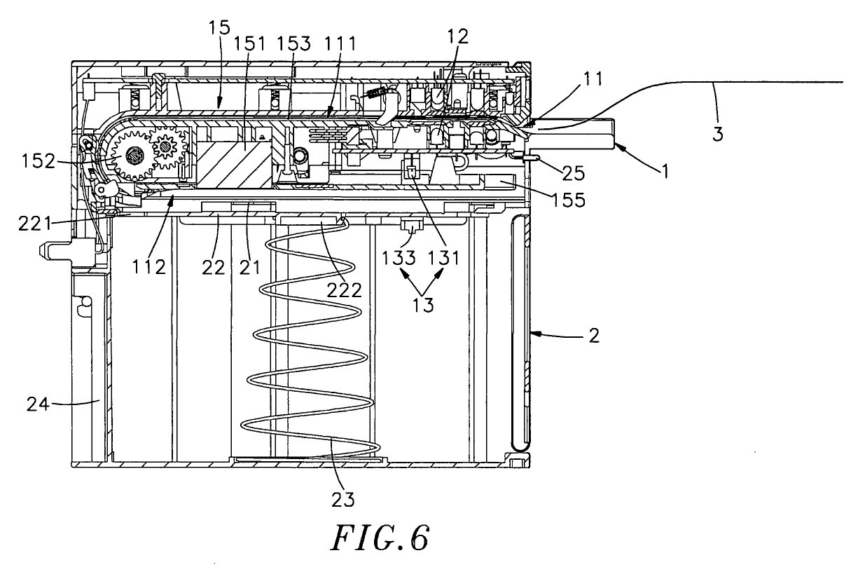

Referring to FIGS. 6˜8, when a bill 3 is inserted through the bill slot 11 into the first bill passage 111, the verification device 12 immediately verifies the authenticity of the inserted bill 3. If the inserted bill 3 is a counterfeit or cannot be verified, the bill conveyer 15 will be operated to return the inserted bill 3 to the bill slot 11. If the inserted bill 11 is verified to be authentic, the bill conveyer 15 will be operated to carry the inserted bill 3 from the first bill passage 111 to the second bill passage 112 and then the flat bearing board 22. When the inserted bill 3 reached the flat bearing board 22, the inserted bill 3 blocks the optical emitter 131 of the sensor 13, and the optical receiver 132 of the sensor 13 receives no signal, and therefore the sensor 13 turns off the indicator light 25. The off status of the indicator light 25 is indicative of the presence of at least one bill in the bill box 2.

The aforesaid sensor 13 is adapted to detect the presence of a bill in the second bill passage 112 so that the worker can know whether there is any bill or not in the bill box 2 without opening the bill box 2. Other sensor means achieves the same effect may be used as a substitute.

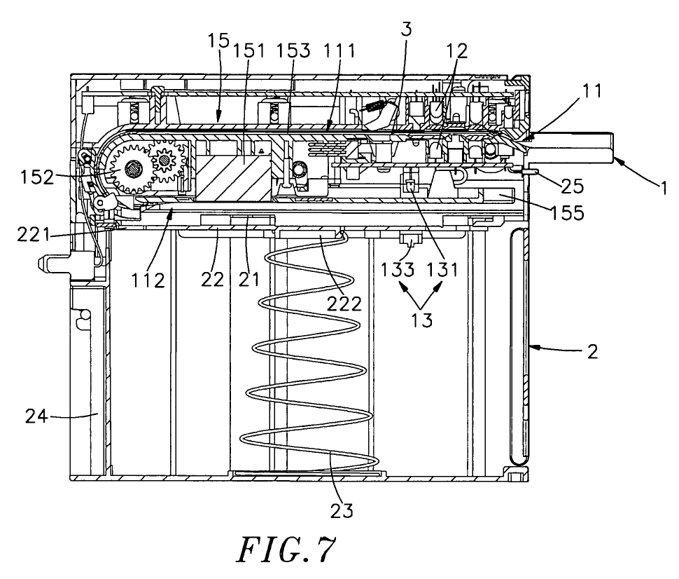

Referring to FIGS. 7˜11, when a bill 3 is inserted into the bill slot 11, the motor 151 of the conveyer 15 is rotated clockwise to drive the transmission gear train 152 to rotate the conveying belts 153 and to further carry the inserted bill 3 from the first bill passage 111 into the second bill passage 112. After the bill 3 has been carried to the second bill passage 112, the motor 151 is reversed to rotate the camshaft 1521 and to further move the crossed linkage 154, thereby causing the crossed linkage 154 to extend out, and therefore the pressure board 155 is moved by the crossed linkage 154 to force the bill 3 toward the flat bearing board 22 against the spring member 23. After the bill 3 has been set in the bill box 2, the motor 151 is continuously rotated in the reversed direction to drive the camshaft 1521 in the sliding slot 1541 of the crossed linkage 154, thereby returning the cross linkage 154 from the extended position to the received position to return the pressure board 155 to its former position, allowing the received bill 3 to be stopped between the flat bearing board 22 and the top rods 21 of the bill box 2 subject to the effect of the spring force of the spring member 23.

According to this embodiment, the spring member 23 is a spiral spring. Other spring means may be used as a substitute.

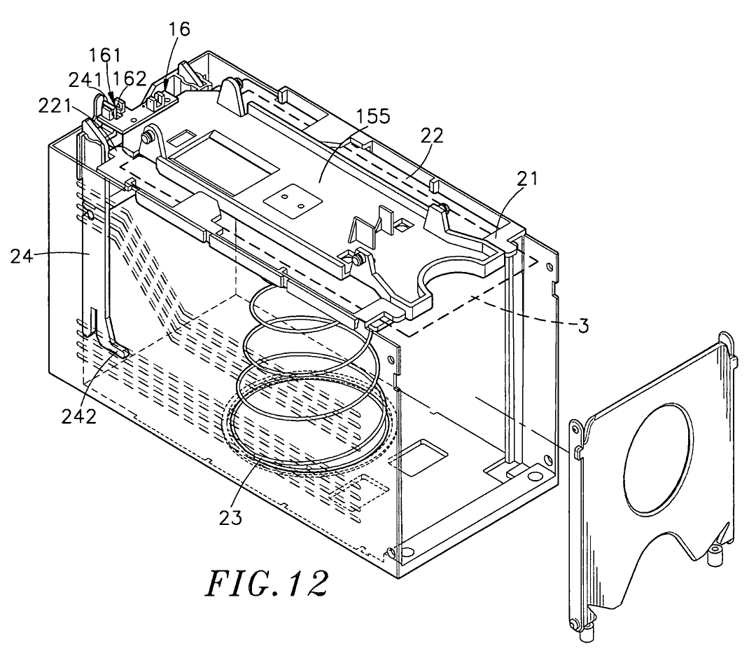

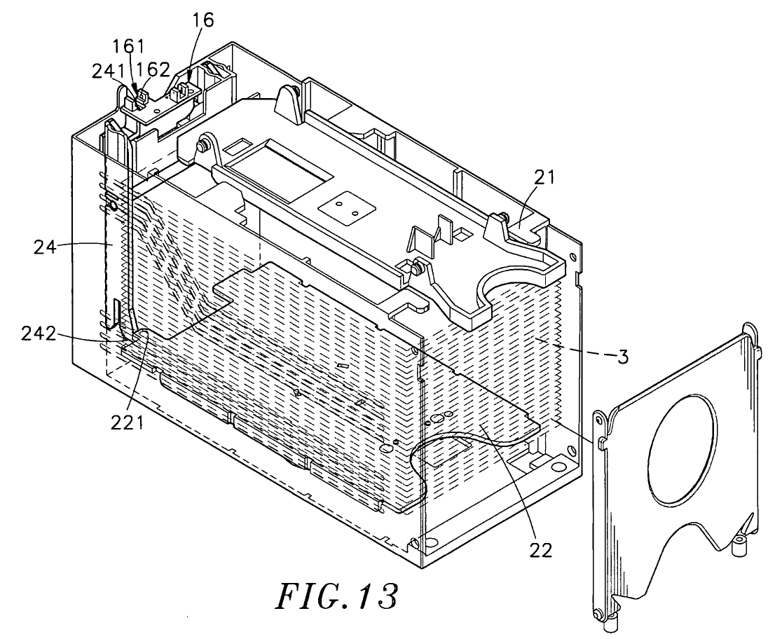

Referring to FIGS. 12 and 13, when the bill conveyer 15 is continuously conveying bills 3 through the second bill passage 112 one after another into the bill box 2, the flat bearing board 22 is relatively lowered with the received bills 3 in the bill box 2. When the flat bearing board 22 is continuously lowered following entrance of bills 3 into the bill box 2, the protruding block 221 of the flat bearing board 22 will be stopped against the protruding rod 242 of the sliding bar 24 to lower the sliding bar 24. When the sliding bar 24 is lowered with the flat bearing board 22 to disengage the stop block 241 from the center through hole 161 of the sensing element 162 of the detector 16, the detector 16 drives the indicator light 25 to give a visual signal indicative of the full status of the bill box 2 and simultaneously cuts off power supply from the money exchanging machine. After the worker has taken the storage bills 3 out of the bill box 2 and put the empty bill box 2 back into the accommodating chamber 14 of the bill receiving and verification unit 1, the indicator light 15 is turned off to give an indication indicative of the empty status of the bill box 2, and power supply is electrically connected to the money exchanging machine again.

As indicated above, the bill acceptor of the present invention has the following characteristics:

1. When a bill 3 enters the second bill passage 112, it blocks the optical emitter 131 and the optical receiver 132, causing the sensor 13 to cut off power supply from the indicator light 25, and the off status of the indicator light 25 is indicative of a condition where the bill box 2 has a bill or bills stored therein.

2. When the bill box 2 is empty, the optical receiver 132 of the sensor 13 receives the light reflected from the optical emitter 131 by the reflecting device 133, and therefore the sensor 13 drives the indicator light 25 to give a visual indication indicative of the empty status of the bill box 2, and at the same time the money exchanging machine is started to work.

3. When a bill 3 is inserted into the bill slot 11, the motor 151 of the conveyer 15 is rotated clockwise to drive the transmission gear train 152 to rotate the conveying belts 153 in one direction, causing the conveying belts 153 to carry the inserted bill 3 from the bill slot 11 through the first bill passage 111 to the second bill passage 112. After the inserted bill 3 has been carried to the second bill passage 112, the motor 151 is reversed to rotate the camshaft 1521, causing the camshaft 1521 to move the crossed linkage 154 from the received position to the extended position, and therefore the pressure board 155 is moved to force the bill 3 toward the flat bearing board 22 of the bill box 2. Therefore, only one single motor is sufficient to achieve the bill receiving function.

4. When the bill box 2 is fully filled with bills 3, the protruding block 221 of the flat bearing board 22 is stopped against the protruding rod 242 of the sliding bar 24 to hold the sliding bar 24 in a lower limit position where the stop block 241 of the sliding bar 24 is kept away from the center through hole 161 of the sensing element 162 of the detector 16, causing the detector 16 to drive on the indicator light 25 and to simultaneously cuts off power supply from the money exchange machine. Therefore, the indicator light 25 gives a visual indication indicative of the full status of the bill box 2.

A prototype of bill acceptor has been constructed with the features of FIGS. 1˜13. The bill acceptor functions smoothly to provide all of the features disclosed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A bill acceptor used in a money exchanging machine, the bill acceptor comprising:
a bill box adapted to collect bills, said bill box comprising a plurality of stop rods suspending around an open side thereof, a flat bearing board adapted to receive bills, spring means, which supports said flat bearing board in said bill box and imparts a forward pressure to said flat bearing board toward said stop rods; and
a bill receiving and verification unit connected to said bill box, said bill receiving and verification unit comprising a bill slot for the insertion of bills, a first bill passage extending from said bill slot, a second bill passage corresponding to said flat bearing board of said bill box, and a conveyer adapted to carry each inserted bill from said bill slot through said first bill passage and said second bill passage to said flat bearing board of said bill box, said conveyer comprising a pressure board movable relative to said bill box and adapted to press each inserted bill onto said flat bearing board for allowing each received bill to be stopped between said flat bearing board and said stop rods of said bill box;
wherein said bill receiving and verification unit comprises a sensor adapted to detect a bill receiving status of said bill box, and indicator means controllable by said sensor to give a first visual indication when said bill box has at least one bill received therein and to give a second visual indication when said bill box is empty, said sensor comprising an optical emitter and an optical receiver disposed in a top side in said second bill passage, and a reflecting device installed in said flat bearing board inside said bill box below said second bill passage and adapted to reflect light from said optical emitter onto said optical receiver.

2. The bill acceptor as claimed in claim 1, wherein said reflecting device comprises a first reflecting element and a second reflecting element, said first reflecting element having a reflecting surface adapted to reflect an emitting light from said optical emitter onto said second reflecting element, said second reflecting element having a reflecting surface adapted to reflect said reflected light from said first reflecting element onto said optical receiver.

3. The bill acceptor as claimed in claim 1, wherein said indicator means is an indicator light that is turned on by said sensor when said bill box has at least one bill received therein and turned off when said bill box is empty.

4. The bill acceptor as claimed in claim 1, wherein said conveyer comprises a reversible motor, conveying belt means adapted to carry each inserted bill from said bill slot through said first bill passage into said second bill passage, and a transmission gear train coupled between said reversible motor and said conveying belt means and adapted to rotate said conveying belt means upon clockwise rotation of said reversible motor, and a crossed linkage connected to said pressure board and adapted to move said pressure board in and out of said bill box, and a camshaft coupled between said reversible motor and said crossed linkage and adapted to reciprocate said cross linkage.

5. The bill acceptor as claimed in claim 4, wherein when said reversible motor is rotated clockwise, said conveying belt means is moved to carry each inserted bill from said bill slot through said first bill passage into said second bill passage.

6. The bill acceptor as claimed in claim 4, wherein when said reversible motor is rotated reverse, said crossed linkage is moved by said camshaft to move said pressure board toward said flat bearing board in said bill box.

7. The bill acceptor as claimed in claim 1, wherein said bill receiving and verification unit further comprises:
a detector installed in one side of said second bill passage and adapted to detect the accumulation status of bills in said bill box and to cut off power supply from said money exchanging machine when a predetermined amount of bills is accumulated in said bill box, said detector comprising a sensing element, said sensing element having a center through hole; and
a sliding bar comprising a stop block disposed at its top side, and a protruding rod disposed at its bottom side and vertically spaced below said protruding block of said flat bearing board;
wherein said vertically slidably mounted in said bill box and movable between a first position where said stop block blocks said center through hole of said sensing element and a second position where said stop block is spaced away from said center through hole of said sensing element, said sliding bar being moved to said second position by said flat bearing board when a predetermined number bills is received in said bill box at said flat bearing board.

9. The bill acceptor as claimed in claim 1, wherein said spring means is a spiral spring.
